(19) United States
(12) Patent Application Publication
(10) Pub. No.: US 2016/0085611 A1
(43) Pub. Date: Mar. 24, 2016

(54) INFORMATION PROCESSING APPARATUS, MANAGEMENT SYSTEM, AND NON-TRANSITORY COMPUTER READABLE MEDIUM

(71) Applicant: FUJI XEROX CO., LTD., Tokyo (JP)

(72) Inventor: Noriyuki ABE, Kanagawa (JP)

(73) Assignee: FUJI XEROX CO., LTD., Tokyo (JP)

(21) Appl. No.: 14/609,584

(22) Filed: Jan. 30, 2015

(30) Foreign Application Priority Data
Sep. 19, 2014 (JP) 2014-191927

(51) Int. Cl. G06F 11/07

(52) U.S. Cl. CPC G06F 11/0772; G06F 11/0751

(57) ABSTRACT

An information processing apparatus includes a unit and an output unit. The unit acquires, from an external apparatus, information regarding a malfunction expected to occur in the information processing apparatus and maintenance schedule information regarding scheduled maintenance to be performed, for the malfunction, on the information processing apparatus and stores the information and the maintenance schedule information in a memory. The output unit outputs the maintenance schedule information in a case where an error has occurred in the information processing apparatus and where the error is associated with the malfunction expected to occur, of which information is stored in the memory.

### CROSS-REFERENCE TO RELATED APPLICATIONS

This application is based on and claims priority under 35 USC 119 from Japanese Patent Application No. 2014-191927 filed Sep. 19, 2014.

### BACKGROUND

### Technical Field

The present invention relates to an information processing apparatus, a management system, and a non-transitory computer readable medium.

### SUMMARY

According to an aspect of the invention, there is provided an information processing apparatus including a unit and an output unit. The unit acquires, from an external apparatus, information regarding a malfunction expected to occur in the information processing apparatus and maintenance schedule information regarding scheduled maintenance to be performed, for the malfunction, on the information processing apparatus and stores the information and the maintenance schedule information in a memory. The output unit outputs the maintenance schedule information in a case where an error has occurred in the information processing apparatus and where the error is associated with the malfunction expected to occur, of which information is stored in the memory.

### BRIEF DESCRIPTION OF THE DRAWINGS

Exemplary embodiments of the present invention will be described in detail based on the following figures, wherein:

FIG. 1 is a diagram illustrating an example of an overall configuration of a management system according to an exemplary embodiment;

FIG. 2 is a functional block diagram illustrating an example of main functions realized by a management apparatus and a maintenance target apparatus according to the exemplary embodiment;

FIG. 3 is a sequence diagram illustrating an example of a flow of a management process performed by a management system according to a first exemplary embodiment;

FIG. 4 is a flowchart illustrating an example of a flow of an output process according to the first exemplary embodiment; and

FIG. 5 is a flowchart illustrating an example of a flow of an output process according to a second exemplary embodiment.

### DETAILED DESCRIPTION

### First Exemplary Embodiment

In the following, a first exemplary embodiment of the present invention will be described in detail with reference to the drawings.

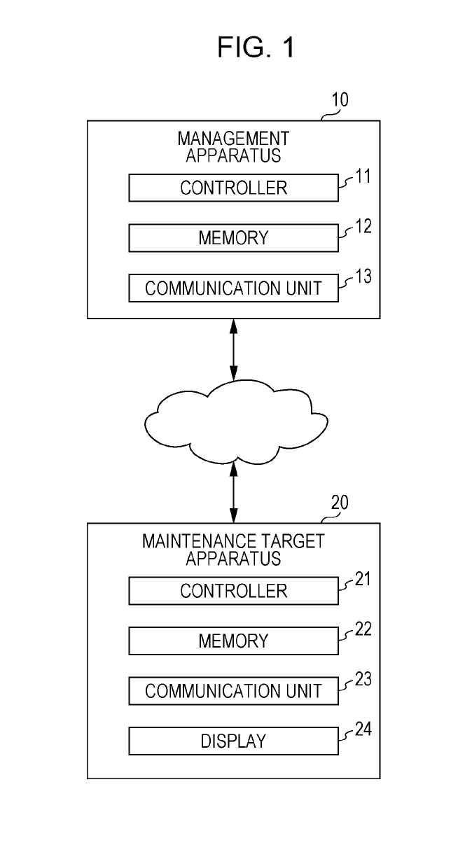

FIG. 1 is a diagram illustrating an example of an overall configuration of a management system 1 according to the first exemplary embodiment. As illustrated in FIG. 1, the management system 1 according to the first exemplary embodiment includes a management apparatus 10 and a maintenance target apparatus 20 (maintenance target apparatuses 20-1 to 20-n). The management apparatus 10 and the maintenance target apparatus 20 are connected to and communicate with each other via a way of communication, examples of which include a local-area network (LAN) and the Internet.

The management apparatus 10 according to the first exemplary embodiment is, for example, a computer such as a server, and includes a controller 11, a memory 12, a communication unit 13, and the like. The controller 11 is a program control device such as a central processing unit (CPU) or the like that operates in accordance with a program installed in the management apparatus 10. The memory 12 is a storage element such as a read-only memory (ROM) or a random-access memory (RAM), a hard disk drive, or the like. The communication unit 13 is a communication interface such as a network board.

The maintenance target apparatus 20 according to the first exemplary embodiment is an apparatus to be subjected to maintenance such as a computer, a multifunction machine, a printer, and the like. The maintenance target apparatus 20 includes a controller 21, a memory 22, a communication unit 23, a display 24, and the like. The controller 21 is a program control device such as a CPU or the like that operates in accordance with a program installed in the maintenance target apparatus 20. The memory 22 is a storage element such as a ROM or a RAM, a hard disk drive, or the like. The communication unit 23 is a communication interface such as a network board. The display 24 is a liquid crystal display or the like.

In the first exemplary embodiment, various sensors are built in the maintenance target apparatus 20, and various internal states of the maintenance target apparatus 20 are detected by these sensors. Information detected here includes information on various types of parameters for an operation of the maintenance target apparatus 20. Then, internal information indicating an internal state detected inside the maintenance target apparatus 20 is transmitted to the management apparatus 10.

The management system 1 is a system for managing maintenance operations for the maintenance target apparatus 20 using internal information acquired from the maintenance target apparatus 20. A user of the maintenance target apparatus 20 is different from a person who does maintenance of the maintenance target apparatus 20. The person who does maintenance visits the place where the maintenance target apparatus 20 is installed at the time of maintenance of the maintenance target apparatus 20. Note that the person who does maintenance of the maintenance target apparatus 20 performs a maintenance operation by remote control via a way of communication using the management apparatus 10 and other information processing apparatuses or copes with cases by telephone. In some cases, when a user finds a malfunction of the maintenance target apparatus 20, he/she asks a person who does maintenance to perform such a maintenance operation. In some cases, such a maintenance operation is performed by a person who does maintenance in a self-motivated manner with reference to internal information.

In the management system 1, the management apparatus 10, which is an external apparatus different from the maintenance target apparatus 20, provides a person who does maintenance and a user with information to be used by a person who does maintenance to efficiently execute a maintenance operation. In particular, in the first exemplary embodiment, it is determined whether or not a request for an unscheduled maintenance (UM) operation is expected to be issued by a user, using internal information acquired at regular intervals from the maintenance target apparatus 20, and information corresponding to a result of the determination is output to the maintenance target apparatus 20. Then, when a malfunction of the maintenance target apparatus 20 occurs, the maintenance target apparatus 20 outputs, in accordance with the malfunction, information acquired from the management apparatus 10.

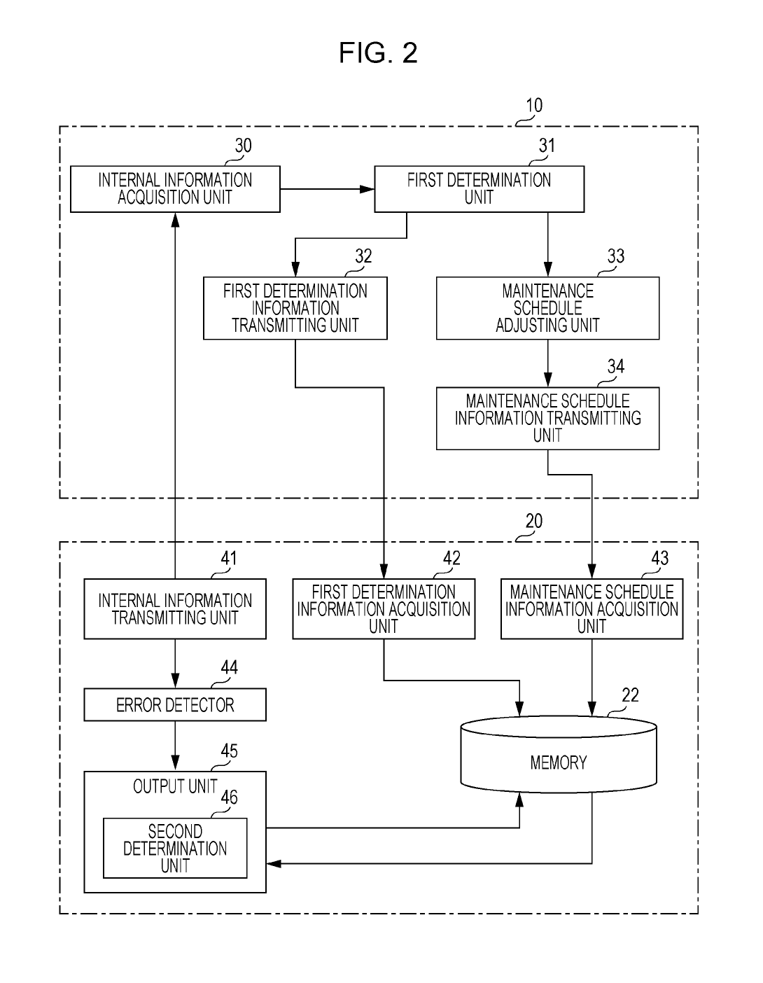

FIG. 2 is a functional block diagram illustrating an example of main functions realized by the management apparatus 10 and the maintenance target apparatus 20 according to the first exemplary embodiment. As illustrated in FIG. 2, the management apparatus 10 according to the first exemplary embodiment includes an internal information acquisition unit 30, a first determination unit 31, a first determination information transmitting unit 32, a maintenance schedule adjusting unit 33, and a maintenance schedule information transmitting unit 34. Note that functions other than the functions illustrated in FIG. 2 may also be realized in the management apparatus 10 according to the first exemplary embodiment. These functions are realized by the controller 11 of the management apparatus 10 executing a program including commands corresponding to these functions, the program being installed in the management apparatus 10, which is a computer. This program is supplied to the management apparatus 10 via, for example, a computer-readable recording medium such as an optical disk, a magnetic disk, a magnetic tape, an magneto-optic disk, a flash memory, or the like, or a way of communication such as the Internet or the like.

The internal information acquisition unit 30 acquires, from the maintenance target apparatus 20, internal information indicating an internal state of the maintenance target apparatus 20 and detected by the maintenance target apparatus 20.

The first determination unit 31 determines whether or not an internal state indicated by internal information acquired by the internal information acquisition unit 30 satisfies a first condition, which is a condition less strict than a second condition, the second condition being a condition under which it is determined that a malfunction has occurred. Here, assume that a state in which the second condition is satisfied is a state in which a malfunction or a failure has occurred in the maintenance target apparatus 20. Assume that a state in which the first condition is satisfied, which is less strict than the second condition, is a state in which the probability of occurrence of a UM operation is greater than or equal to a certain value. Specifically, the state in which the first condition is satisfied is a state better than the state in which the second condition is satisfied and is a state in which a UM operation is expected to occur before long in accordance with an elapsed time and use conditions of the maintenance target apparatus 20. In addition, a malfunction or a failure indicates a state of the maintenance target apparatus 20 in which it is necessary to perform a maintenance operation for the maintenance target apparatus 20. Some malfunctions or failures may be recognized by users, and some are not recognized by users but specified by persons who do maintenance. In addition, in the case where the maintenance target apparatus 20 is a multifunction machine, a certain malfunction, an example of which is a paper jam, is detected by sensors as a type of internal information within the maintenance target apparatus 20, and a certain malfunction, an example of which is image quality, is not easily and directly detected by sensors. In the first exemplary embodiment, a state of the maintenance target apparatus 20 in which it is determined that the second condition is satisfied is a state in which the probability of occurrence of a UM operation is greater than or equal to a certain value.

A first condition and a second condition are prestored in the memory 12 of the management apparatus 10 as correspondence information associated with a cause of occurrence of a UM operation. A cause of occurrence of a UM operation is a malfunction that has caused a user to ask for a maintenance operation among malfunctions of the maintenance target apparatus 20. Correspondence information includes causes of occurrence of a UM operation. In the correspondence information, for each cause of occurrence of the UM operation, one or more internal states are associated with the cause of occurrence of the UM operation. In the correspondence information, for each internal state, a first condition and a second condition are associated with the internal state. In this manner, an internal state associated with a cause of occurrence of a UM operation is an internal state represented by a numerical value, examples of which include the number of times at which a member is driven and a toner density value, and is an internal state treated as an index of the cause of occurrence of the UM operation.

In addition, a first condition and a second condition may also be calculated in accordance with information on UM operations that have occurred in the past. For example, every time a UM operation occurs, a numerical value of an internal state associated with a cause of occurrence of the UM operation is acquired, and the cause of occurrence of the UM operation, the numerical value of the internal state, and details of the maintenance operation are associated with one another and stored as maintenance operation information in the memory 12. The details of a maintenance operation include the date and time when the maintenance operation is performed, a detailed action done in the maintenance operation (for example, toner cartridge replacement, component replacement, and the like). For each cause of occurrence of a UM operation, a numerical value of an internal state serving as a condition for occurrence of the UM operation is statistically calculated in accordance with such maintenance operation information. The numerical value of the internal state serving as a condition for occurrence of the UM operation calculated in this manner may also be treated as the second condition. Then, the first condition is set to a value smaller than the value of the second condition. For example, the first condition is set to a value that is 80% of the value of the second condition.

The first determination information transmitting unit 32 transmits first determination information to the maintenance target apparatus 20, the first determination information including internal information indicating an internal state determined by the first determination unit 31 to satisfy the first condition and expected-malfunction information regarding a malfunction corresponding to the internal state determined by the first determination unit 31 to satisfy the first condition (hereinafter referred to as a malfunction expected to occur). Note that the maintenance target apparatus 20 may acquire the first determination information by accessing the management apparatus 10.

The maintenance schedule adjusting unit 33 adjusts a maintenance operation schedule in the case where the first determination unit 31 has determined that an internal state indicated by internal information acquired by the internal information acquisition unit 30 satisfies the first condition. Assume that, in the first exemplary embodiment, maintenance schedule information indicating a maintenance operation schedule is stored in the memory 12, and a periodic maintenance operation schedule is stored as an initial value for the maintenance schedule information. Then, the maintenance schedule adjusting unit 33 changes the maintenance operation schedule indicated by the maintenance schedule information stored in the memory 12. The maintenance schedule adjusting unit 33 may change the maintenance operation schedule in accordance with the periodic maintenance operation schedule. For example, when a periodic maintenance operation is scheduled within the next several days (for example, within one week), the maintenance schedule adjusting unit 33 does not change the maintenance operation schedule. When a periodic maintenance operation is not scheduled within the next several days, the maintenance schedule adjusting unit 33 may newly schedule a maintenance operation to be performed within the next several days. Then, the changed maintenance schedule information is stored in the memory 12. Note that the maintenance schedule adjusting unit 33 may adjust the maintenance operation schedule in accordance with a command issued by a person who does maintenance. In the case where the first determination unit 31 has determined that an internal state indicated by internal information acquired by the internal information acquisition unit 30 satisfies the first condition, a command may be output to cause a person who does maintenance to adjust the maintenance operation schedule and the person who does maintenance may adjust the maintenance operation schedule in accordance with the command. The person who does maintenance may arbitrarily adjust the maintenance operation schedule. As described above, a maintenance operation schedule may also be changed in accordance with a periodic maintenance operation schedule. Note that even in the case where a periodic maintenance operation is not scheduled to be performed within the next several days, a maintenance operation may not be newly scheduled.

The maintenance schedule information transmitting unit 34 transmits maintenance schedule information adjusted by the maintenance schedule adjusting unit 33 to the maintenance target apparatus 20. Note that the maintenance target apparatus 20 may acquire maintenance schedule information by accessing the management apparatus 10.

The maintenance target apparatus 20 according to the first exemplary embodiment includes an internal information transmitting unit 41, a first determination information acquisition unit 42, a maintenance schedule information acquisition unit 43, an error detector 44, an output unit 45, and a second determination unit 46. Note that functions other than the functions illustrated in FIG. 2 may also be realized in the maintenance target apparatus 20 according to the first exemplary embodiment. These functions are realized by the controller 21 of the maintenance target apparatus 20 executing a program including commands corresponding to these functions, the program being installed in the maintenance target apparatus 20, which is a computer. This program is supplied to the maintenance target apparatus 20 via, for example, a computer-readable recording medium such as an optical disk, a magnetic disk, a magnetic tape, an magneto-optic disk, a flash memory, or the like, or a way of communication such as the Internet or the like.

The internal information transmitting unit 41 transmits internal information indicating an internal state of the maintenance target apparatus 20 and detected by the maintenance target apparatus 20 to the management apparatus 10. The internal information transmitting unit 41 may transmit internal information to the management apparatus 10 at regular intervals (for example, once a day), or may transmit internal information to the management apparatus 10 at irregular intervals.

The first determination information acquisition unit 42 acquires first determination information transmitted by the first determination information transmitting unit 32 of the management apparatus 10 and stores the first determination information in the memory 22.

The maintenance schedule information acquisition unit 43 acquires maintenance schedule information transmitted by the maintenance schedule information transmitting unit 34 of the management apparatus 10 and stores the maintenance schedule information in the memory 22.

The error detector 44 detects errors of the maintenance target apparatus 20. The error detector 44 is generally a detector for detecting an error code that has occurred in the maintenance target apparatus 20; however, the error detector 44 may acquire information on an internal state of the maintenance target apparatus 20 at regular intervals and perform error detection, or may monitor an internal state of the maintenance target apparatus 20 at all times and perform error detection. The error detector 44 acquires information on an internal state of the maintenance target apparatus 20 and determines that an error has occurred in the maintenance target apparatus 20 in the case where the internal state, the information on which has been acquired, satisfies a condition under which it is determined that a malfunction has occurred in the maintenance target apparatus 20, the case where some kind of error code has occurred, or the like. Here, conditions under which it is determined that an error has occurred in the maintenance target apparatus 20 are generally different from those under which an internal state of the maintenance target apparatus 20 is determined by the first determination unit 31 of the management apparatus 10; however, these conditions may also be the same.

When the error detector 44 detects an error of the maintenance target apparatus 20, the output unit 45 outputs maintenance schedule information stored in the memory 22 to the display 24. The maintenance schedule information output to the display 24 may indicate only the presence or absence or a maintenance operation schedule, or may also indicate a maintenance-operation schedule date, details of a maintenance operation, and the like. Note that the maintenance schedule information does not have to be output to the display 24, and may also be output as audio information.

In addition, the output unit 45 may also output maintenance schedule information stored in the memory 22 to the display 24 in accordance with a determination result of the second determination unit 46. The second determination unit 46 determines whether or not an error detected by the error detector 44 is associated with a malfunction that is a cause for which the occurrence of a UM operation is expected by the first determination unit 31 of the management apparatus 10. For example, in the case where a malfunction for which the occurrence of a UM operation is expected by the first determination unit 31 of the management apparatus 10 is a “paper jam” and an error detected by the error detector 44 is a “paper jam”, a “jam”, or the like, it is determined that the malfunction is associated with the error. Specifically, when the error detector 44 detects an error, the second determination unit 46 checks information regarding a malfunction corresponding to an internal state determined to satisfy the first condition, the information being included in the first determination information. Then, in the case where it is determined that the information regarding the malfunction is associated with the error detected by the error detector 44, it is determined that the error detected by the error detector 44 is a malfunction for which the occurrence of a UM operation is expected by the first determination unit 31 of the management apparatus 10. In this case, there is a possibility that a UM operation occurs that is expected to occur by the first determination unit 31 of the management apparatus 10. Then, in the case where it is determined that the information regarding the malfunction is not associated with the error detected by the error detector 44, it is determined that the error detected by the error detector 44 is not a malfunction for which the occurrence of a UM operation is expected by the first determination unit 31 of the management apparatus 10. In this case, there is a low probability that a UM operation occurs that is expected to occur by the first determination unit 31 of the management apparatus 10. Then, only in the case where the second determination unit 46 has determined that the error detected by the error detector 44 is a malfunction for which the occurrence of a UM operation is expected, the output unit 45 may output maintenance schedule information to the display 24.

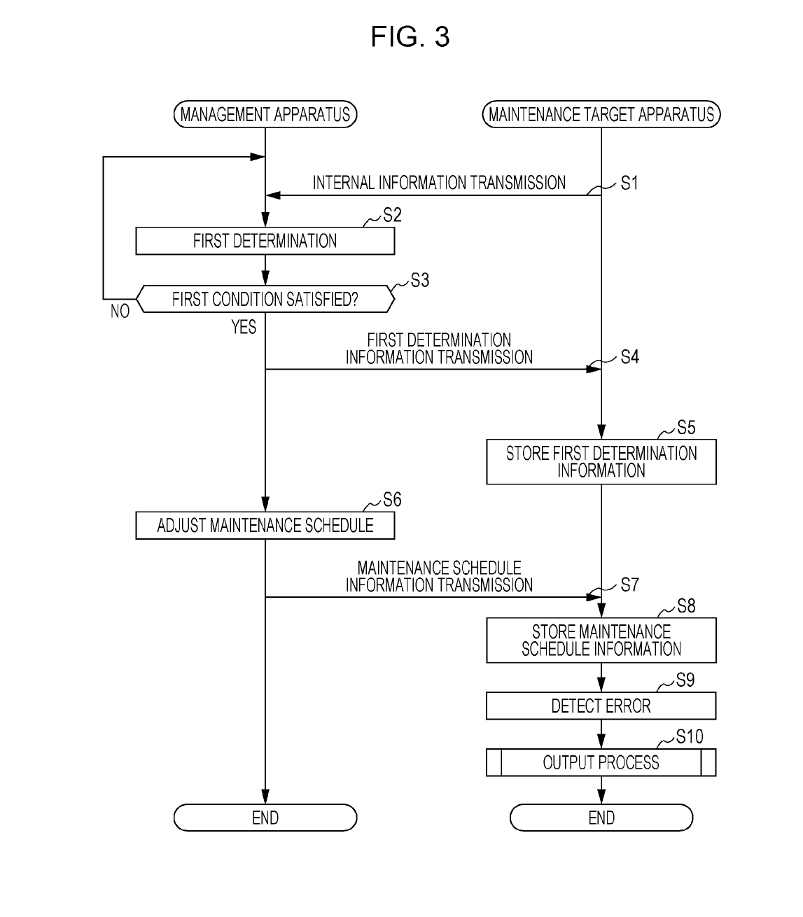

Here, an example of a flow of a management process performed by the management system 1 according to the first exemplary embodiment will be described with reference to a sequence diagram illustrated in FIG. 3.

First, the internal information transmitting unit 41 of the maintenance target apparatus 20 transmits internal information to the management apparatus 10 (S1). Then, the internal information acquisition unit 30 of the management apparatus 10 acquires the internal information (S2).

The first determination unit 31 of the management apparatus 10 determines whether or not an internal state indicated by the internal information acquired by the internal information acquisition unit 30 of the management apparatus 10 satisfies a first condition, which corresponds to the internal state (S3).

As a result of determination performed in step S3, in the case where it is determined that the internal state indicated by the internal information acquired by the internal information acquisition unit 30 of the management apparatus 10 satisfies the first condition (Yes in S3), the first determination information transmitting unit 32 of the management apparatus 10 transmits first determination information to the maintenance target apparatus 20 (S4), the first determination information including information regarding the internal state determined to satisfy the first condition and information regarding a malfunction corresponding to the internal state determined to satisfy the first condition. Then, the first determination information acquisition unit 42 of the maintenance target apparatus 20 acquires the first determination information transmitted by the first determination information transmitting unit 32 of the management apparatus 10 and stores the first determination information in the memory 22 of the maintenance target apparatus 20 (S5).

Then, the maintenance schedule adjusting unit 33 of the management apparatus 10 adjusts a maintenance operation schedule (S6). Then, maintenance schedule information indicating the maintenance operation schedule adjusted by the maintenance schedule adjusting unit 33 of the management apparatus 10 is stored in the memory 12. Then, the maintenance schedule information transmitting unit 34 of the management apparatus 10 transmits the maintenance schedule information stored in the memory 12 to the maintenance target apparatus 20 (S7).

The maintenance schedule information acquisition unit 43 of the maintenance target apparatus 20 acquires the maintenance schedule information transmitted by the maintenance schedule information transmitting unit 34 of the management apparatus 10 and stores the maintenance schedule information in the memory 22 of the maintenance target apparatus 20 (S8).

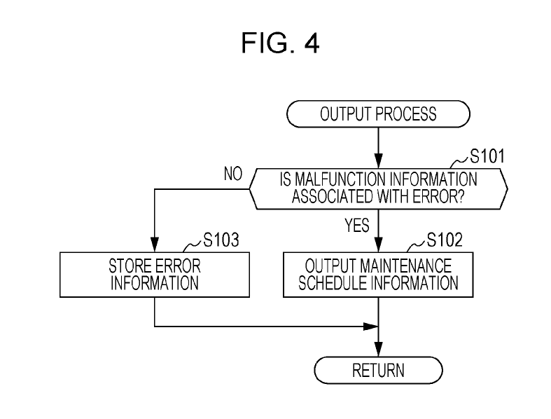

When the error detector 44 of the maintenance target apparatus 20 detects an error of the maintenance target apparatus 20 (S9), the output unit 45 of the maintenance target apparatus 20 performs an output process (S10). After the output process is performed in step S10, the management process ends. In the output process, information is output that should be presented to a user in response to the occurrence of an error of the maintenance target apparatus 20. The output process performed in step S10 will be described with reference to a flowchart of FIG. 4.

[First Output Process]

As illustrated in FIG. 4, first, in the case where the second determination unit 46 of the maintenance target apparatus 20 has determined that the information regarding the malfunction and included in the first determination information stored in the memory 22 of the maintenance target apparatus 20 is associated with the error detected by the error detector 44 (Yes in S101), the output unit 45 of the maintenance target apparatus 20 outputs the maintenance schedule information stored in the memory 22 of the maintenance target apparatus 20 to the display 24 (S102) and the process returns to the flowchart of FIG. 3.

In the case where the second determination unit 46 of the maintenance target apparatus 20 has determined that the information regarding the malfunction and included in the first determination information stored in the memory 22 of the maintenance target apparatus 20 is not associated with the error detected by the error detector 44 (No in S101), error information regarding the error detected by the error detector 44 of the maintenance target apparatus 20 is stored in the memory 22 of the maintenance target apparatus 20 (S103) and the process returns to the flowchart of FIG. 3. Here, an error has occurred that is not associated with a malfunction expected to occur, that is, an error has occurred that is not expected to occur. Thus, information on the error is stored as error information such that a person who does maintenance may check the information. The error information includes, for example, an error code, details of an error, a value of an internal state corresponding to the error, an occurrence date and time of the error code, and the like. Then, a person who does maintenance refers to the error information when he/she performs a maintenance operation for the maintenance target apparatus 20.

In addition, as a result of determination performed in step S3, in the case where it is determined that the internal state indicated by the internal information acquired by the internal information acquisition unit 30 of the management apparatus 10 does not satisfy the first condition (No in S3), the process in and after step S1 is repeatedly performed.

### Second Exemplary Embodiment

In the above-described first exemplary embodiment, for each cause of occurrence of a UM operation, a first condition and a second condition are associated with the cause of occurrence of the UM operation in the correspondence information prestored in the memory 12 of the management apparatus 10. In a second exemplary embodiment, for each cause of occurrence of the UM operation, additional conditions are further associated with the cause of occurrence of the UM operation, the additional conditions being conditions under which a malfunction tends to occur, which is a cause of occurrence of the UM operation. For example, in the case where a malfunction is a paper jam, when it is recognized that the malfunction tends to occur under certain conditions, examples of which include large-volume printing, double-sided printing, and first printing after power is switched on, whether or not a job commanded by a user corresponds to these conditions is associated, as additional conditions, with a cause of occurrence of a UM operation. Assume that the first determination information includes additional-condition information indicating additional conditions under which malfunctions expected to occur and indicated by expected-malfunction information tend to occur.

In addition, in the case where it is determined that an error detected by the error detector 44 is associated with a malfunction expected to occur, the second determination unit 46 determines whether or not a job, which is a cause of the error, satisfies an additional condition included in the first determination information. Here, it is determined whether or not the additional condition is actually satisfied, which is recognized as a condition under which a certain malfunction tends to occur. In the case where the additional condition is satisfied, handling information corresponding to the additional condition is presented to a user. In that case, the output unit 45 outputs the handling information corresponding to the additional condition together with the maintenance schedule information stored in the memory 22 of the maintenance target apparatus 20 to the display 24. Handling information is information indicating a method to handle the maintenance target apparatus 20 until a person who does maintenance performs a maintenance operation, and may be a warning that causes the maintenance target apparatus 20 not to be operated under a certain condition under which a malfunction expected to occur tends to occur (an additional condition). For example, in the case where a paper jam, a malfunction, has occurred, the output unit 45 outputs and displays a warning, an example of which including “Large-Volume Printing is Prohibited”, “Double-sided Printing is Prohibited”, and the like.

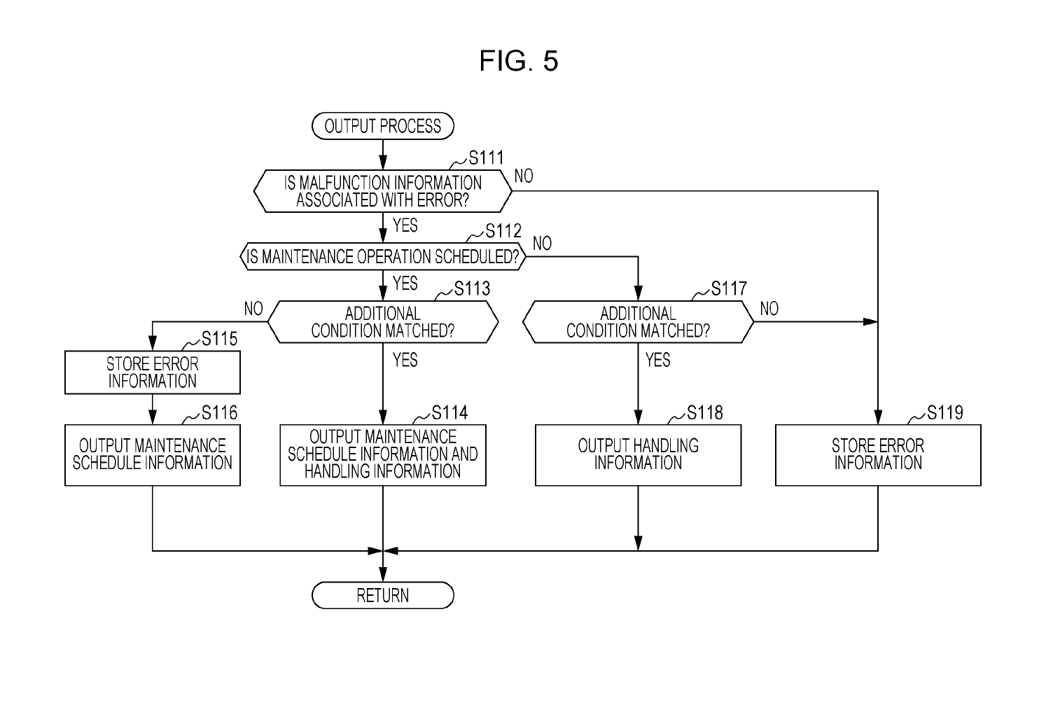

Here, an example of a flow of a management process performed by the management system 1 according to the second exemplary embodiment will be described. The management process performed by the management system 1 according to the second exemplary embodiment is the same as that in the first exemplary embodiment except that details of the output process in step S10 in the sequence diagram illustrated in FIG. 3 are different. Thus, a redundant description will be omitted here. The output process in step S10 in the second exemplary embodiment will be described with reference to a flowchart of FIG. 5.

[Second Output Process]

As illustrated in FIG. 5, first, in the case where the second determination unit 46 of the maintenance target apparatus 20 has determined that an error detected by the error detector 44 is associated with a malfunction expected to occur by the first determination unit 31 of the management apparatus 10 (Yes in S111), it is determined whether or not a maintenance operation is scheduled with reference to the maintenance schedule information stored in the memory 22 of the maintenance target apparatus 20 (S112).

As a result of determination performed in step S112, in the case where it is determined that a maintenance operation is scheduled (Yes in S112), the second determination unit 46 of the maintenance target apparatus 20 determines whether or not there is an internal state of the maintenance target apparatus 20 matching an additional condition indicated by the additional-condition information included in the first determination information (S113). Specifically, for example, it is determined whether or not a job commanded by a user immediately before an error occurs matches an additional condition.

As a result of determination performed in step S113, in the case where there is an internal state of the maintenance target apparatus 20 matching the additional condition indicated by the additional-condition information included in the first determination information (Yes in S113), the output unit 45 of the maintenance target apparatus 20 outputs, to the display 24, the maintenance schedule information stored in the memory 22 and handling information corresponding to the additional condition determined to match the internal state of the maintenance target apparatus 20 in step S113 (S114) and the process returns to the flowchart of FIG. 3. Here, both information on the scheduled maintenance operation and the method to handle the maintenance target apparatus 20 until the scheduled maintenance operation is performed are presented to the user.

As a result of the determination performed in step S113, in the case where there is no internal state of the maintenance target apparatus 20 matching the additional condition indicated by the additional-condition information included in the first determination information (No in S113), error information regarding the error detected by the error detector 44 of the maintenance target apparatus 20 in step S9 of FIG. 3 is stored in the memory 22 of the maintenance target apparatus 20 (S115). Then, the output unit 45 of the maintenance target apparatus 20 outputs the maintenance schedule information stored in the memory 22 to the display 24 (S116) and the process returns to the flowchart of FIG. 3.

As a result of the determination performed in step S112, in the case where it is determined that no maintenance operations are scheduled (No in S112), the second determination unit 46 of the maintenance target apparatus 20 determines whether or not there is an internal state of the maintenance target apparatus 20 matching an additional condition indicated by the additional-condition information included in the first determination information (S117).

As a result of determination performed in step S117, in the case where there is an internal state of the maintenance target apparatus 20 matching the additional condition indicated by the additional-condition information included in the first determination information (Yes in S117), the output unit 45 of the maintenance target apparatus 20 outputs, to the display 24, handling information corresponding to the additional condition determined to match the internal state of the maintenance target apparatus 20 in step S117 (S118) and the process returns to the flowchart of FIG. 3.

In the case where the second determination unit 46 of the maintenance target apparatus 20 has determined that the error detected by the error detector 44 is not associated with a malfunction expected to occur by the first determination unit 31 of the management apparatus 10 (No in S111) or in the case where, as a result of the determination performed in step S117, there is no internal state of the maintenance target apparatus 20 matching the additional condition indicated by the additional-condition information included in the first determination information (No in S117), the error information regarding the error detected by the error detector 44 of the maintenance target apparatus 20 in step S9 of FIG. 3 is stored in the memory 22 of the maintenance target apparatus 20 (S119) and the process returns to the flowchart of FIG. 3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a unit that acquires, from an external apparatus, information regarding a malfunction expected to occur in the information processing apparatus and maintenance schedule information regarding scheduled maintenance to be performed, for the malfunction, on the information processing apparatus and stores the information and the maintenance schedule information in a memory; and
an output unit that outputs the maintenance schedule information in a case where an error has occurred in the information processing apparatus and where the error is associated with the malfunction expected to occur, of which information is stored in the memory.

2. The information processing apparatus according to claim 1, wherein
the unit further acquires information regarding a condition under which the malfunction tends to occur and stores the information regarding the condition in the memory, and
the output unit further outputs, in a case where a job executed before the error has occurred satisfies the condition, information indicating the condition.

3. A non-transitory computer readable medium storing a program causing a computer to execute a process, the process comprising:
acquiring, from an external apparatus, information regarding a malfunction expected to occur in an information processing apparatus and maintenance schedule information regarding scheduled maintenance to be performed, for the malfunction, on the information processing apparatus and storing the information and the maintenance schedule information in a memory; and
outputting the maintenance schedule information in a case where an error has occurred in the information processing apparatus and where the error is associated with the malfunction expected to occur, of which information is stored in the memory.

4. A management system comprising:
an external apparatus; and
an information processing apparatus, wherein
the external apparatus includes a transmitting unit that transmits, to the information processing apparatus, information regarding a malfunction expected to occur in the information processing apparatus and maintenance schedule information regarding scheduled maintenance to be performed, for the malfunction, on the information processing apparatus, and
the information processing apparatus includes an output unit that outputs the maintenance schedule information in a case where an error has occurred in the information processing apparatus and where the error is associated with the malfunction expected to occur, of which information is stored in the memory.
